(19) United States
(12) Patent Application Publication
(10) Pub. No.: US 2004/0019457 A1
(43) Pub. Date: Jan. 29, 2004

(54) Performance management using passive testing

(76) Inventor: Khaled A. Arisha, Columbia, MD (US)

Correspondence Address: Michele Burris Holden, Honeywell International Inc., Patent Services, Law Dept. AB2, P.O. Box 2245, Morristown, NJ, 07962-2245, US

(21) Appl. No.: 10/369,607

(22) Filed: Feb. 21, 2003

Related U.S. Application Data
(60) Provisional application No. 60/398,830, filed on Jul. 29, 2002.

(51) Int. Cl. G21C 17/00; G06F 11/30

(52) U.S. Cl. 702/182

(57) ABSTRACT

A method of detecting performance flaws in a network using passive testing includes modeling a communicating finite state machine (CFSM) having a plurality of machines, at least some of which are connected to each other via a plurality of channels, wherein each machine is defined as a single node six-tuple FSM along with a time stamp. An observer is placed at selected ones of the plurality of nodes, the observer being able to compute delays, throughput and utilization. The observer observes input/output sequences for the selected nodes and compares those input/output sequences with predetermined expected behaviors. This results in identifying areas of the machine in which discrepancies between the input/output sequences and the expected behaviors occur, and for an area so identified (i) the time stamp and arrival time of a selected input/output sequence is monitored to compute an end-to-end delay of a corresponding input/output pair, (ii) the number of input/output pairs passing through one of the selected nodes is monitored to determine whether the number is above or below a predetermined number per unit of time, and (iii) a utilization factor is determined for a selected channel in the communicating finite state machine.

This application claims the benefit of U.S. Provisional Application No. 60/398,8309, filed Jul. 29, 2002, which is herein incorporated by reference in its entirety.

### REFERENCES

The following references, which are incorporated herein in their entirety, are cited throughout this disclosure.

[1] K. Arisha, “Fault Management in Avionics Telecommunication using Passive Testing,” Digital Avionics Systems Conference (DASC), Daytona Beach, Fla., Oct. 2001.

[2] K. Arisha, “Fault Management in Networks using Passive Testing,” Ph.D. Thesis Dissertation, Computer Science Department, University of Maryland at College Park, May 2001.

[3] R. E. Miller and K. Arisha, “On Fault Location in Networks by Passive Testing,” 2000 IEEE International Performance Computing and Communications Conference, Phoenix, Ariz., February 2000.

[4] R. E. Miller and K. Arisha, “On Fault Location in Networks by Passive Testing,” Technical Report #4044, Computer Science Dept., University of Maryland College Park, August 1999.

[5] R. E. Miller and K. Arisha, “On Fault Identification in Networks by Passive Testing,” Technical Report CS TR#4207/UMIACS TR#2001-03, Computer Science Dept., University of Maryland College Park, August 1999.

[6] R. E. Miller and K. Arisha, “Fault Identification in Networks by Passive Testing,” Advanced Simulation Technologies Conference (ASTC), Seattle, Wash., April 2001.

[7] R. E. Miller and K. Arisha, “On Fault Identification in Networks by Passive Testing,” Technical Report CS TR#4240/UMIACS TR#2001-28, Computer Science Dept., University of Maryland College Park, April 2001.

[8] R. E. Miller and K. Arisha, “Fault Identification in Networks Using a CFSM Model by Passive Testing,” the Tenth International Conference on Telecommunication Systems, Modeling and Analysis (ICTS), Monterey, Calif., October 2002.

[9] R. E. Miller and K. Arisha, “On Fault Coverage in Networks by Passive Testing,” Technical Report CS TR#4220/UMIACS TR#2001-10, Computer Science Dept., University of Maryland College Park, February 2001.

[10] R. E. Miller and K. Arisha, “Fault Coverage in Networks by Passive Testing,” International Conference on Internet Computing (IC), Las Vegas, Nev., June 2001.

[11] R. E. Miller and K. Arisha, “On Fault Management using Passive Testing for Mobile IPv6 Networks,” Technical Report CS TR#4226/UMIACS TR#2001-15, Computer Science Dept., University of Maryland College Park, March 2001.

[12] R. E. Miller and K. Arisha, “Fault Management using Passive Testing for Mobile IPv6 Networks,” GlobeComm, San Antonio, Tex., November 2001.

[13] R. E. Miller, “Passive Testing of Networks using a CFSM Specification,” 1998 IEEE International Performance Computing and Communications Conference, pp. 111-116, February 1998.

[14] R. E. Miller, “Passive Testing of Networks Using a CFSM Specification,” Bell Labs Technical Memorandum, BL011345-97-0522-03TM, May 20^{th}, 1997.

[15] D. Lee, A Netravali, K. Sabnani, B. Sugla, and A. John, “Passive Testing and Applications to Network Management,” Proceedings of IEEE International Conference on Network Protocols, pp. 113-122, October 1997.

[16] W. Stallings, “SNMP, SNMPv2, and CMIP The Practical Guide to Network-Management Standards,” Addison-Wesley Publishing Company, 1993.

[17] ISO/IEC 7498-1: 1994|ITU-T Recommendation X.200 (1994) Information Technology—Open Systems Interconnection—Basic Reference Model: The Basic Model, 1994.

[18] D. Brand and P. Zafiropulo, “On Communicating Finite-State Machines,” JACM, Vol. 30, No. 2, pp. 323-42, April 1983.

[19] S. C. Johnson and R. W. Butler, “Formal Methods,” Avionics Handbook, CRC Press.

[20] B. Duterte and V. Stavridou, “Formal Requirement Analysis of an Avionics Control System,” IEEE Trans. on Software Engineering, Vol. 33, No. 5, may 1997, pp. 267-277.

[21] Federal Aviation Regulation FAR 25-1309, amendment 25-41.

[22] Advisory Circulation AC 25-1309-1A, “System Design and Analysis,” FAA 1988.

[23] FANS Manual, International Air Transport Association, Montreal, Version 1.1, May 1995.

[24] Aeronautical Telecommunication Network (ATN) International Standards and Recommended Practices (SARPs), ICAO, March 1997.

[25] Paul M. Fitts, “Human Engineering for an Effective Air-Navigation and Traffic-Control System,” National Research Council, (1951), p. 5-11.

[26] ARP 4754, “Certification Consideration for Highly-Integrated or Complex Aircraft Systems,” 1996 SAE, and EUROCAE ED-79.

[27] DOD-HDBK-763, “Human Engineering Procedures Guide,” 1987.

### BACKGROUND

1. Field of the Invention

The present invention is directed to telecommunication systems and methods that provide information with respect to performance management. More particularly, the present invention is directed to communication systems and methods that detect performance flaws in a reasonable time, that use formal modeling, and that integrate seamlessly with other network assessment regimes such as fault management.

2. Background of the Invention

Because of rapid growth in avionics telecommunication networks and the fast evolution in its technological avenues, the need for a more efficient and effective network management approach becomes more urgent. For example, in the emerging “free flight” paradigm, pilots are given more flexibility to select and update their routes in real time in order to reduce costs and to increase system capacity. To handle the requirements associated with the necessary capabilities that underlie paradigms such as free flight, future air traffic control systems need such a new network management technique.

The International Standard Organization (ISO) has defined network management for the Open System Interconnection (OSI) seven-layer model in terms of five functional areas: fault management, performance management, accounting management, configuration management, and security management [17]. A considerable effort has been made to standardize network management protocols and develop network management systems, such as the Simple Network Management Protocol (SNMP) and the Common Management Information Protocol (CMIP) [16]. However, there is much to be done towards formally specifying problems in network management and developing formal techniques to solve these problems. For the Avionics industry, despite the powerful advantages of formal specification and formal methods [19], there is still a great need for verification to uncover faults and unexpected performance failures [20].

The Federal Aviation Administration (FAA) emphasizes that single failure conditions should be extremely improbable [21]. Fail-safe design principles require failure warnings and indicators [22]. Machines excel in monitoring, performance routine, repetitive, or very precise operations, responding very quickly to control signals [25]. Cockpit Design purposes include: detailed analysis of time-critical sequences—i.e., whether all events can be performed in the available time, flag incompatible concurrent tasks, and input to workload evaluation [26]. Highly integrated systems are systems that perform or contribute to multiple aircraft-level functions [26].

In view of the complexity and criticality of existing avionics (or any other mission critical) systems, it is important to be able to study, investigate, characterize and identify network performance.

### SUMMARY OF THE INVENTION

Aspects of the present invention model a network (herein focused exclusively on avionics networks, but which could be virtually any network that can be modeled using similar techniques) using the formal approaches of Finite State Machine (FSM) as is done in [15] and of Communicating FSMs (CFSM) as in [13][14]. Techniques, features and aspects of the modeling in accordance with the present invention are illustrated by applying them to an avionics telecommunication network example.

Systems and methods related to those of the present invention are described in a paper titled “Fault management in avionics telecommunication using passive testing,” which was presented in 2001 [1]. The present invention has its focus on another critical functional area of network management; namely “performance management.” There are two approaches to test a network: active testing and passive testing. The most commonly used approach is active testing, which gathers information actively by injecting test messages into the network to aid in finding network problems. In addition to active testing checking for dead links and nodes, active testing has techniques in common with conformance testing of protocols. Conformance testing is used to test protocols off-line to ensure that a protocol implementation conforms to its specification. Test sequences are generated from the specification. These input sequences are applied to the implementation to see whether the produced output sequence matches the expected one given by the specification. However, most of network management in real systems takes place while the network is in use. Because of this, it is desirable to keep traffic overhead associated with testing to a minimum.

Passive testing observes the normal traffic of the network, without adding any test messages. Thus, passive testing enables examining the input-output behavior of the network without forcing the network to any test input sequences. It is realized that good results with respect to fault management can be achieved using passive testing only. Heretofore, however, a passive testing based network management approach has not been applied to implement performance management and obtain corresponding results.

In accordance with principles of the present invention, an implementation of a given network under test is viewed as a “black box” where only the input-output behavior is observable. The problem is to determine whether the behavior of the implementation conforms to the behavior of the specification. If it does not conform, this implies the existence of a performance failure. For fault management purposes, Lee et al [15] apply passive testing on a single FSM model of a network for fault detection. In [13][14], Miller uses a variant of the CFSM model to specify a network, and shows that some fault location information could be deduced. But fault detection is not sufficient. Once a fault is detected, other remedial steps are required to eliminate the fault. Fault location helps by isolating the corrective actions to only a portion of the network. Thus, additional fault location capability by passive testing would be very useful if faults could be isolated to ever-smaller regions, as demonstrated by Miller and Arisha [3][4]. Additionally, if the exact fault that occurred could be limited to a small set of possibilities, this would further simplify the corrective activities. Fault identification is known by those skilled in the art, as exemplified by [6][7][9]. Fault coverage determines what percentage of faults is known to be detectable by passive testing [9][10]. Additional details for the integrated fault management approach can be found in [2], and its application to mobile networks can be found in [1][11][12].

Models of passive observation are often used to measure numerically performance metrics including, typically, end-to-end delay, throughput, and utilization. The passive testing approach of the present invention, however, is extended to include timing as a new dimension to the model. Although the real-time dimension might appear orthogonal to fault management, it nevertheless adds robustness to the passive testing results. Real-time measurements in passive testing are observable information that may, through observation, provide results about a “change in performance” rather than a “faulty indication”. With the passive testing suite of the present invention (fault detection, location, identification and coverage), it is possible to decide when and where a performance flaw happens and to provide some guidance to take corrective actions. The following description presents how each of the common performance metrics can be measured using the extended passive testing approach according to the present invention.

### BRIEF DESCRIPTION OF THE DRAWINGS

FIG. 1 is an example of a FSM model and the passive testing fault detection algorithm according to the present invention.

FIG. 2 shows multiple node cuts through a large network splitting the network into smaller regions in accordance with the present invention.

FIG. 3 shows a 3-node configuration with a passive-testing observer in accordance with the present invention.

FIG. 4 shows an observed input/output sequence corresponding to the configuration shown in FIG. 3, in accordance with the present invention.

FIG. 5 shows possible observer locations in accordance with the present invention.

FIG. 6 depicts a model of the Aeronautical Telecommunication network (ATN) layer protocol with a 4-node CFSM model.

FIG. 7 illustrates the FSM representing one node—of FIG. 6—executing the subnetwork access protocol layer.

FIGS. 8-12 show results for simulation of the integrated fault/performance management process, in accordance with the present invention, applied to the model in FIGS. 6-7.

FIG. 13 illustrates an exemplary series of steps for practicing aspects of the present invention.

### DETAILED DESCRIPTION OF THE INVENTION

In the following description, the CFSM model is employed for avionics telecommunication networks to investigate performance management using passive testing. First, the concept of passive testing is introduced. Then, the CFSM model and the observer model are introduced with appropriate assumptions and justification. Also introduced are the failure model and, briefly, the fault detection and location algorithms using passive testing. Finally, the new passive testing approach for performance management based on the CFSM model is presented along with an illustration of the effectiveness of the new technique through simulation of a practical avionics telecommunication protocol example, namely, the Aeronautical Telecommunication Network (ATN) [24].

A. The Model

In this section, we introduce the passive testing based model used for fault management with recommended extension to support performance management. The CFSM model for network specification and the observer model will be described as follows. First, the FSM based model is presented as a description of the single node structure of the CFSM, together with associated assumptions and justifications for the model. Then, the CFSM model is introduced. The observer model is described next. Finally, the fault model is presented together with the performance flaw model.

1. The Node Model

A single node is modeled as a deterministic finite state machine (DFSM) M. M is a six-tuple: M=(I, O, S, s₀, δ, λ, t) where:

I, O, and S are finite non-empty sets of input symbols, output symbols, and states respectively.

s₀ is a designated initial state.

δ: S×I→S is the state transition function;

δ: S×I→O is the output function.

When the machine is in state s in S and receives an input α in I, it moves to the next state specified by δ(s, α) and produces an output given by λ(s, α). Parameter t is the real-time value. It is mainly used to time-stamp the input/output symbols when generated.

We denote the number of states, inputs, and outputs by n=|S|, p=↑I|, and q=|O|, respectively.

Assumptions: We assume that if a fault occurs, only one fault occurs during a test cycle. For more detail about justification of these assumptions, refer to [2][13-15] [18].

2. The CFSM Model

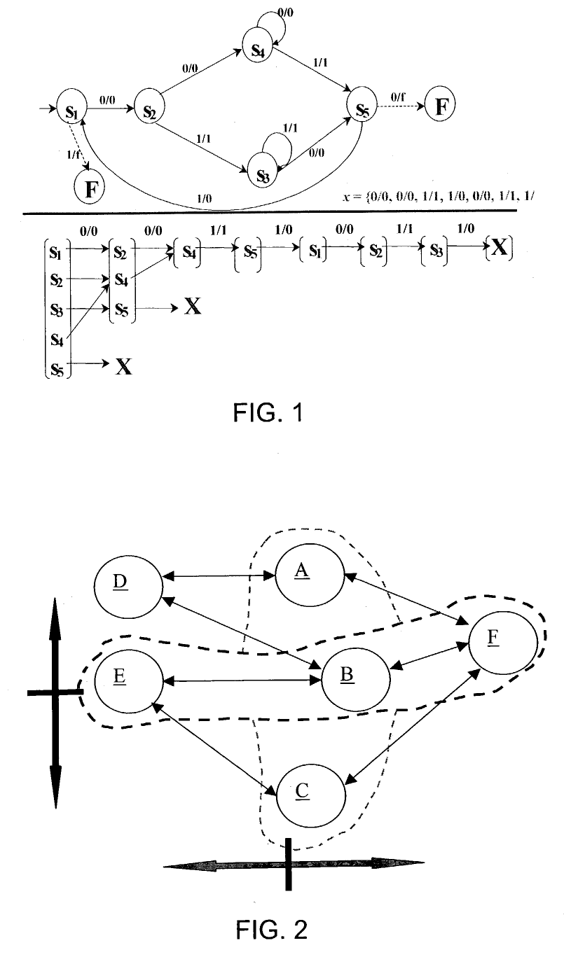

The model is based on the node model of DFSM as described in FIG. 1. Representing a huge network by a single DFSM would result in a very large machine, whereas using a machine for each node provides a distributed representation with each machine being relatively simple. So, we choose to propose a variant of the Communicating Finite State Machines (CFSM), where the network is modeled as a set of machines, one for each node of the network, with channels connecting these nodes [18]. This variant uses the Mealy model formulation rather than the send/receive labeling of transitions which is used in the original CFSM model, that is, here we have input/output labeling on transitions.

A CFSM consists of a set of machines M, and a set of channels C. We specify our network N=(M, C), where

M={m₁, m₂, . . . , mᵣ} is a finite set of r machines, and C={Cᵢⱼ: i,j≦r\hat{ }i≈j} is a finite set of channels,

For each machine m∈M, we define the deterministic finite state machine (DFSM) m as a six-tuple; m=(I, O, S, s₀, δ, λ), as defined above.

Each channel Cᵢⱼ∈C represents a communication channel from mᵢ to mⱼ. It behaves as a First-In-First-Out (FIFO) queue with mⱼ taking inputs from the head of the queue and mᵢ placing outputs into the tail of this queue for messages produced by mᵢ that are intended for mⱼ. Detail about assumptions can be found in [4].

3. The Observer

Each observer will be placed at a certain node in the network. Let A represent a machine specification at a node where the observer is placed. The observer is assumed to know the specification structure of A, so it can trace the input/output tuples observed with the specified state transitions of A. For the implementation machine B the observer sees the input/output behavior of the FSM representing this node as a black box, and the observer compares B's input/output sequence with the specified sequence of A.

The observer should be able to compute delays, throughput and utilization as explained later.

Assumptions: We assume that the network topology of the implementation is the same as the specification. When more than one node of the network has an observer, we assume that there is some way to gather the information from these observers for fault analysis. The node is viewed as a black box FSM for the observer. For more detail about justification of these assumptions, refer to [4].

4. The Fault Model

Due to our assumptions of the CFSM model used in passive testing, the three types of faults that we can investigate, in terms of the CFSM specification, are:

Output Fault: This occurs when a transition has the same head and tail states and the same input as in the specification FSM, but the output is altered.

Tail State Fault: This occurs when a transition has the same head state and input/output symbols as specified, but the tail state is altered.

Channel Fault: This occurs when a channel corrupts a message (i.e. an input and/or output symbol)

According to our selected performance metrics, a new set of performance flaws can be detected:

Delay flaws: This occurs when a packet is delayed, a packet is lost, or a channel is broken.

Throughput flaws: This occurs when the throughput at a specific node falls below the acceptable level.

Utilization flaw: This occurs when the channel utilization is too high, i.e. congested, or too low, i.e. underutilized.

Assumptions: Only a single fault or a single flaw exists on the network. Also, faults/flaws in the nodes are persistent, while faults/flaws in the channels are non-persistent.

B. Fault Detection

Passive testing fault detection for a network using the FSM model was first developed in [15]. The fault detection capability of passive testing can be summarized as follows. As an input/output sequence of the implementation machine B is observed, it is compared with the expected behavior of the specification FSM A. B is considered “faulty” if its behavior is different from that of A. That is, there is no state in A that would display the observed input/output sequence. The procedure for detecting this is to first start out with the set L⁰ consisting of all states of A, since we do not know what state A is supposedly in at the start of the observed input/output sequence. Then, with the first observed input/output i₁/o₁, we compute a new set of states L¹, the successor states of A from states in L⁰. This process is continued for each iⱼ/oⱼ to produce an L^{j} set from L^{j-1}. If at some point L^{j} becomes a singleton set then the sequence up to this point is called a passive homing sequence. If at some point k L^{k} becomes empty, we know that B is faulty since no state in A could produce this observed input/output sequence.

A detailed algorithm that describes the above procedure is in [15]. An example of a FSM model and the passive testing fault detection algorithm is shown in FIG. 1, where x is the observed input/output sequence.

C. Fault Location

Referring to the fault location work on the two-node model done by Miller [13][14], the detected fault can be characterized with respect to its location in the network. More elaboration to generalize the fault location work is given in [3][4]. From this work, analysis done at the observer can be viewed as a node cut through a large network splitting the network into three parts: the cut and the two sides of the cut, as shown in FIG. 2. To get finer location we can consider multiple node-cuts such that these cuts, together, create relatively small regions for the network. Using our fault location capabilities through each cut, we will be able to locate a fault to a smaller region as follows.

In FIG. 2, the node cut passing through ABC can have 3 observers, one at each node over this node cut. By combining the fault location that is reported from each observer, we can determine whether the fault is located in the cut or to the left or right side of that node cut. If we look at the other node cut passing through EBF which can also have 3 observers, one at each node of this node cut, we determine whether the fault is in the cut or above or below that node cut. If we combine the location information from both these edges, we can isolate a region of the network where the fault resides. This leads to more precision in the fault location approach. Subsequent active testing can be applied to the isolated region to determine what fault occurred in that region of the network.

Further work has been done for fault identification for both the single FSM model [5][6] and the CFSM model [7][8], as well as for fault coverage [9][10]. These fault management capabilities, however, are not related to the performance management described herein. For more integrated view of fault management with its applications refer to [2][12].

D. Performance Management

This section covers the performance management approach based on passive testing. It describes how the performance metrics are observed and calculated, as well as the approach to detect performance flaws using this information. The approach is presented as integrated add-on features to the known fault management suite.

1. End-to-End Delay

For End-to-End Delay to be measured, each input/output pair in the tuple can be time-stamped at the source node (where the pair is generated), and then timed at the destination node (where the pair is consumed). In accordance with the present invention, the definition of input/output tuple is extended to include the tuple generation time.

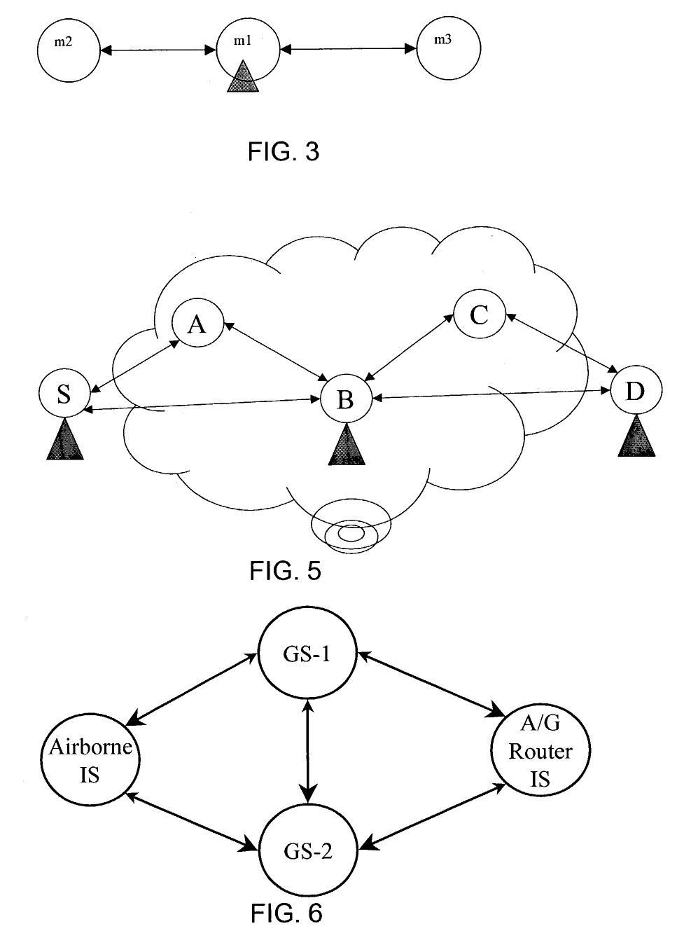

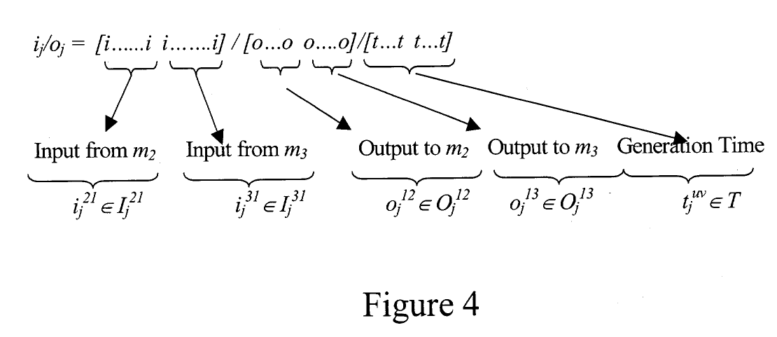

For the 3-node configuration shown in FIG. 3 and it associated input/output sequence shown in FIG. 4, assume iⱼ and oⱼ for m₁ consist of input tuples and output tuples between m₂ and m₃, respectively. T is the measured real-time. The parameter tⱼ^{uv} refers to the original generation time of the input/output pair iⱼ/oⱼ while the pair is currently transmitted from node u to node v.

In order to be able to measure the end-to-end delay, an observer should be located at the destination node of the tuple, node D in FIG. 5. For that case, the observer calculates the arrival time and evaluates the end-to-end delay of the input/output pair. However, this location for the observer behaves poorly regarding the fault location capability, since the node cut passing through this observer can not achieve an improved smaller region. So, locating an observer at a destination, or end, node raises a tradeoff between the effectiveness of the fault location and the end-to-end delay.

For the cases where fault location capability is more important, it is typically necessary to locate observers at internal nodes such as node B in FIG. 5, but then the end-to-end delay can not be measured. Despite this, the approach can still achieve partial results regarding the delay between the source and the observed node, i.e., how long it takes the input/output pair to be sent from node S to node B.

If we measure the delay, either end-to-end delay or the source-to-observed delay, and use the history of measured delays, some learning process, or customer based requirement, we can produce reasonable thresholds for this delay, i.e., the maximum-allowed delay and the average/acceptable delay. We can define delay performance flaws as follows:

If a packet is received and exceeds the average/acceptable threshold for delay, a performance flaw is detected as “delayed packet.”

If a packet is expected and is not received within the maximum-allowed threshold for delay, a performance flaw is detected as “lost packet.”

If all packets to be received via a specific channel within the maximum-allowed threshold for delay are not received, a performance flaw is detected as “broken channel.”

2. Throughput

Defining throughput in terms of the number of input/output tuples passing through a node in a time unit, the observer model can be extended to count such tuples and divide the total by the number of elapsed time units. One of the reasonable thresholds for throughput is the minimum-acceptable throughput. We can define the following throughput performance flaw:

If the throughput falls below the acceptable threshold, a performance flaw is detected as “Low Throughput.”

3. Utilization

To measure utilization of a specific channel, we need to locate an observer at one end of the channel to be able to calculate the percentage of time the channel is used. A couple of reasonable thresholds for utilization are the maximum-allowed utilization and the minimum-acceptable utilization. We can define the following utilization performance flaws:

If the utilization falls below the acceptable threshold, a performance flaw is detected as “Underutilized Channel.”

If the utilization exceeds the maximum-allowed threshold, a performance flaw is detected as “Congested Channel.”

Thus, to extend the passive testing based fault management to include performance based network management features, our approach is modified to enable the observer to compute delays, throughput and utilization.

The fault detection approach, described in a previous section, should evaluate at each observation time whether the current value of any performance metric triggers a performance flaw to be reported. Depending on the performance based network management policy, the observer may log an error and pursue its normal functionality or may halt similar to the fault detection. For the purpose of this description, to be more consistent with the fault detection scheme, we choose to halt when a performance flaw is detected.

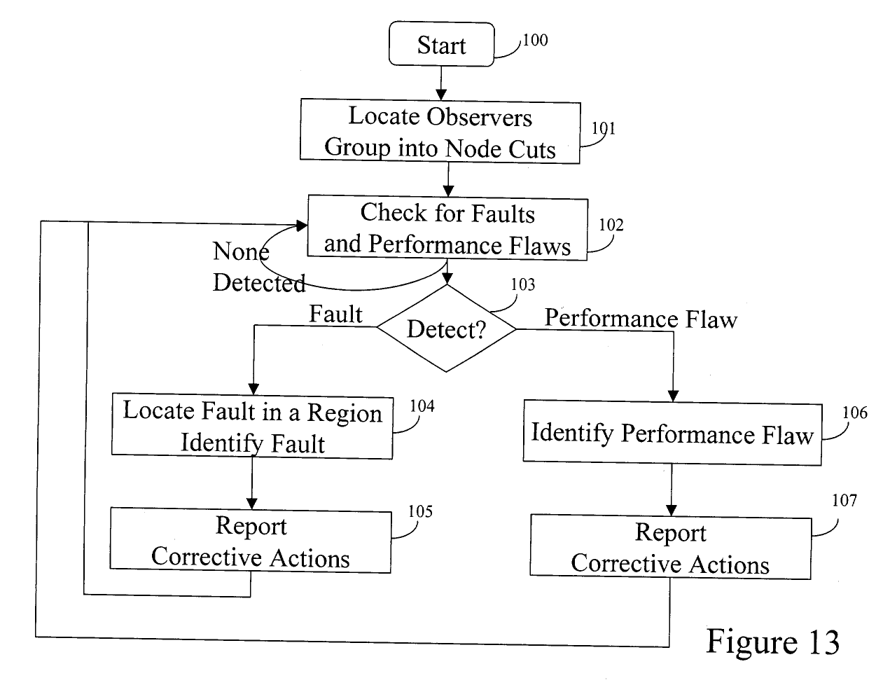

FIG. 13 illustrates an exemplary series of steps for practicing aspects of the present invention. Since the features of the present invention have been described as “add-ons” to fault management techniques, and indeed, it would be quite possible that both fault management and performance management techniques could be practiced simultaneously, FIG. 13 shows both of these management functions in operation. Specifically, the process begins at step 100 and then step 101 observer groups are located into node cuts. A check is then made at step 102 for both faults and performance flaws. If neither is detected, then process simply loops back to step 102. On the other hand, if a fault has been detected at step 103, then the fault is located in a particular region and the fault is identified at step 104 and then a report is made and corrective actions are taken at step 105. The process then loops back to step 102.

If a performance flaw is detected at step 103, then it is identified at step 106 and a report is made and corrective actions are taken at step 107. The process then loops back to step 102.

E. Experiments

To investigate the effectiveness of the passive testing based network management approach just discussed for our CFM model, we model the Aeronautical Telecommunication network (ATN) layer protocol with a 4-node CFSM model shown in FIG. 6, and simulate the passive testing techniques we have just described. First we give a brief introduction for the ATN stack layout, then we discuss the CFSM model, the simulation and the results.

The ATN has been conceived of as a ground internet supporting in-flight aircraft communication with the ground internet over mobile subnetworks. The ATN provides a high availability scaleable internetwork making use of the existing infrastructure, whilst supporting mobile communications. Its prioritized resource management permits Air Traffic Control (ATC) and Airline Operational Communications to share the same data links. The ATN design is based on the ISO OSI Reference Model and associated ISO OSI standardized data communications protocols. The ATN is comprised of End Systems, Intermediate Systems (more generally known as Routers) and subnetworks. The function of an ATN End System (Host) is to provide the end-user applications with an OSI compliant communications interface to enable them to communicate with remote end-user applications. ATN End System implementation of the protocols required for Layers 1 and 2 (i.e., Physical and Data Link), and subnetwork access functions in layer 3, is purely a local issue and wholly dependent on the subnetwork to which the particular End System is attached. The function of an ATN Intermediate System (Router) is to relay data between different ATN subnetworks (air-ground or ground-ground), such that ATN End Systems may exchange data even when they are not directly attached to the same subnetwork.

Here we choose the Very High Frequency (VHF) Data Link Mode 2 (VDL-2) subnetwork. We select to model the network layer 3 protocol, namely the subnetwork access protocol based on the ISO 8208 standards. This protocol is implemented on Aircraft Intermediate System (IS), Ground Stations and Air/Ground (IS) Router.

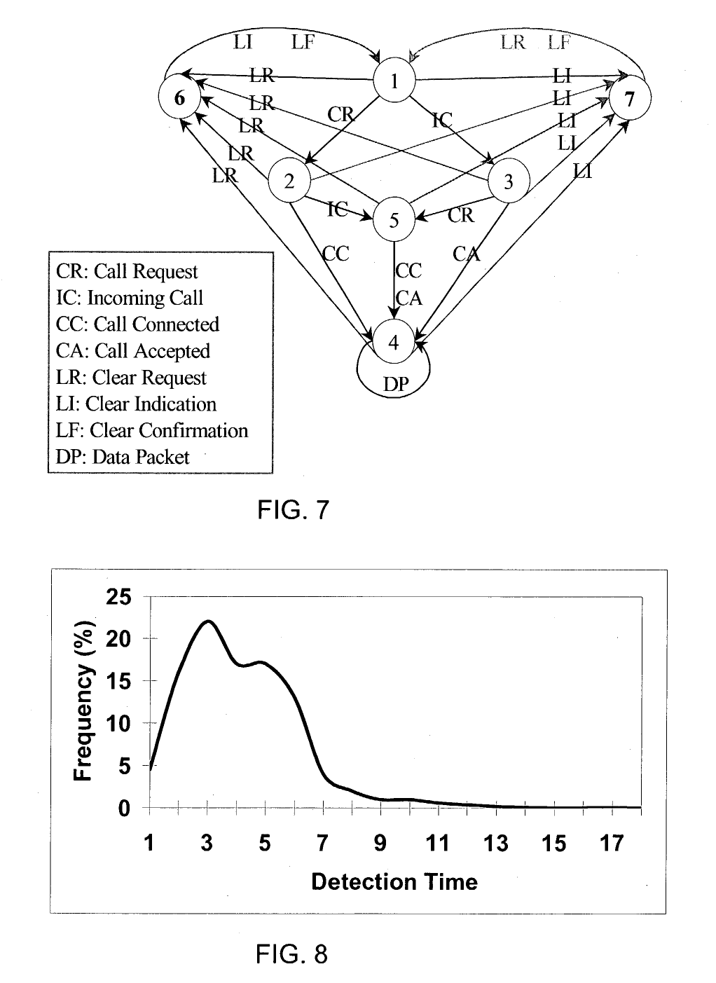

As shown in FIG. 6, our model has one Airborne IS and one Air/Ground Router (Ground-IS) connected through the two Ground Stations (GS-1 and GS-2) using the VDL-2 subnetwork. The links connecting the airborne IS node to the GSs are wireless VHF-based links, while the links connecting the GSs and the Air/Ground Router IS are wireline. Using our CFSM model, we place an observer at each of the Ground Stations. FIG. 7 illustrates the FSM representing one node executing the subnetwork access protocol layer.

Placing the observer at selected nodes (GS-1, GS-2) in the network shown in FIG. 6, we generate faults/flaws randomly and inject them in the system. Random generation of faults/flaws sets the following:

Fault/Flaw location: whether in a node or a channel.

Fault/Flaw time: when the fault/flaw is injected.

Fault/Flaw class: based of the fault characterization and performance flaw classes mentioned above.

Fault/Flaw identity: For the fault case: if the fault is located inside nodes, it tells which transition and whether it is an output or tail-state fault. If the fault is in channels it tells how the symbol is altered. For the performance flaw case: the identity defines the real cause behind this flaw, such as slow node processing or overloaded channel.

For the faults, time is measured in atomic steps, where one atomic step is equivalent to the time it takes for a transition to be executed in one FSM (i.e., a node). The simulator reports the fault detection time and the fault location information. For the flaw cases, real-time measurements are used to calculate metrics, and compare them against the thresholds to detect the flaw. The simulator functionality can be summarized as follows:

First, the simulator generates the fault/flaw randomly as explained above. It either selects randomly a fault and time/location to inject it into the system, or it selects a random real-time value to inject the event initiating the performance flaw in the system.

Then, the fault/flaw detection analysis is performed assuming that the observers are at the node cuts. It computes the set of possible states {Lⁱ} for each observer and computes the set of performance metrics until either a fault is detected {Lⁱ=φ} or a performance flaw is triggered, by at least one of the observers. Using the fault characterization, we can get fault location information.

The simulator computes the following results: fault detection time since injection, number of located faulty entities, performance flaw detection time since injection, and some time progression for performance metrics to illustrate their detection. Aggregate analysis, such as histograms and averages of these parameters; are computed for the whole set of tests.

Running the experiment for 50,000 random faults/flaws injected into the system and the integrated fault/performance management process simulated, the final results are illustrated as follows in FIGS. 8-12.

It can be seen that most of the detection times are between 2 and 6 (FIG. 8). The passive testing based fault management does not take long to detect the fault once injected.

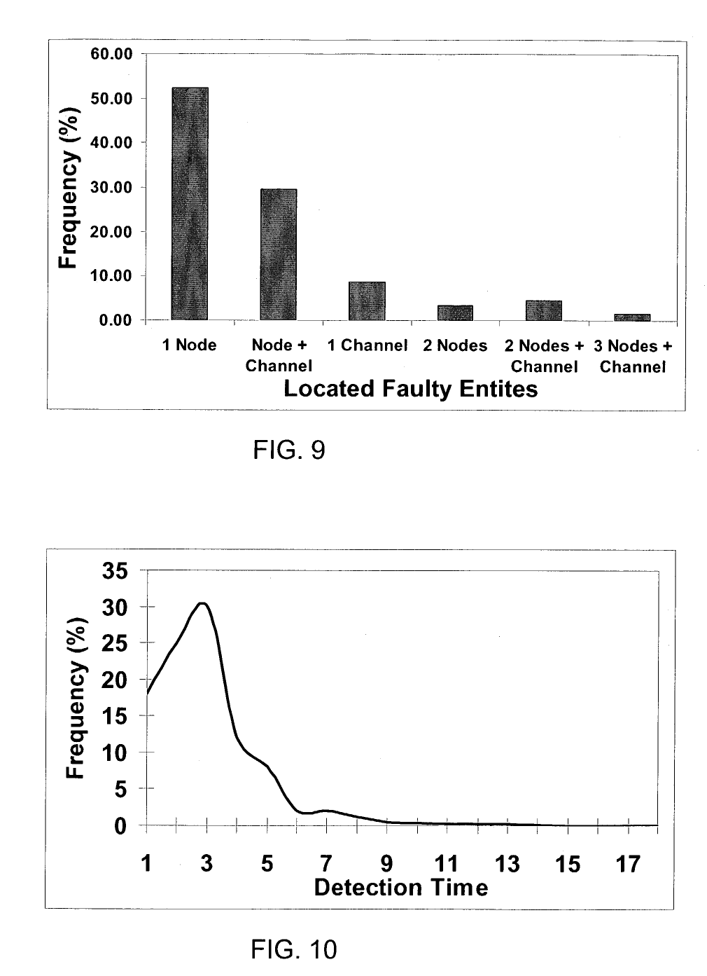

It can also be seen that more than half of the time, the fault is located in just one entity (one node or one channel) (FIG. 9). More than 90% of the time the fault is located within one node and/or one of its channels. With this observation, we can realize that the fault location can enhance the active corrective process in this 4-node network example. It reduces the uncertainty about fault location from the whole network to only a few entities.

It can be noticed that most of the time, the performance flaw detection time is between 2.0 and 3.5 real-time units (FIG. 10). This verifies that the performance management based on passive testing is very efficient in detecting performance flaws.

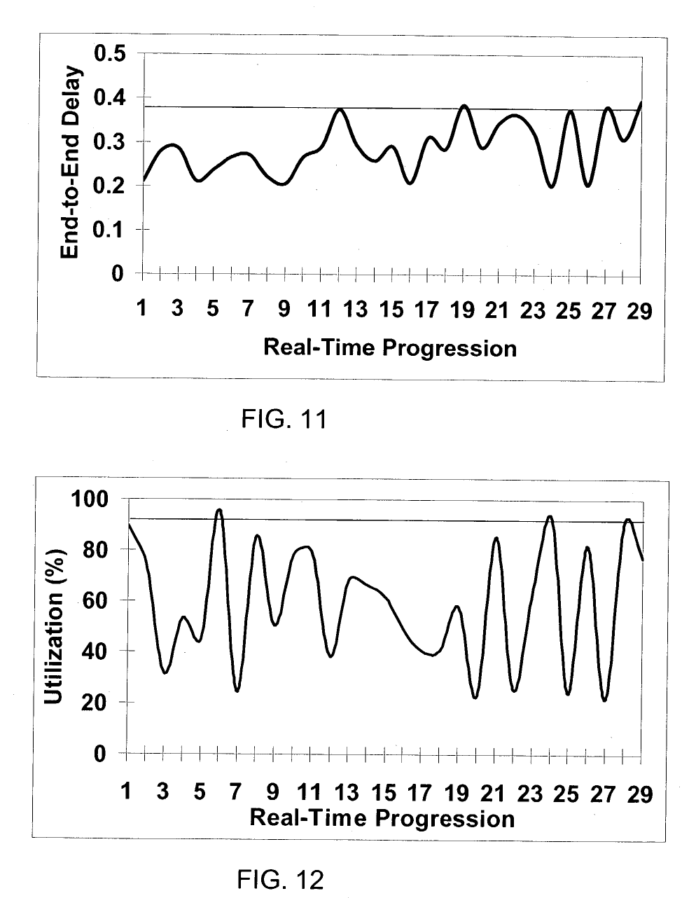

Now, we illustrate some time progression examples of our performance metric measurements. From the data of FIG. 11, where end-to-end delay was measured between the two IS-nodes, the measured delay exceeds the threshold for the delayed packets.

Utilization time progression for the channel between the two IS-nodes is illustrated in FIG. 12, which shows how the underutilized and the congested channel flaws are detected.

F. Summary and Possible Extensions

1. Summary

We have shown how passive testing on a practical example (a 4-node ATN network) can be used in both fault and performance management. The model and experiment show how successful is the extension of the passive testing based fault management to support performance management capabilities as well. In the foregoing, the focus for fault management has been on fault detection and fault location capabilities, and the focus for performance management has been on performance flaw detection.

With respect to the extension for passive testing to include the real-time as a new dimension to our model, although the real-time dimension may seem orthogonal to our fault management work, it proves to add robustness to our passive testing results. Real-time measurements in passive testing are observable information that can, through observation, provide results about “changes in performance” rather than “faulty indication”. With our integrated passive testing based network management suite (fault management and performance management), we illustrate here how to use this experience to decide when a fault or a performance flaw happens and to provide some guidance to take corrective actions.

An ATN network model was used to demonstrate the effectiveness of the approach on a practical example. Extensive simulation was done for this example over many simulated input/output sequences and many random injections of faults/flaws. This simulation demonstrated that:

For fault detection capability, the results demonstrate that the average time to detect a fault in our experiment is quite low (between 2 and 6 steps). That is, it does not take long for passive testing to detect a fault;

For fault location information, the results show that our approach—in most of the cases—reduces the suspected faulty region. Thus, one obtains a reduction in the amount of work required for the active corrective phase; and

For performance flaw detection, the simulation results are very promising. The passive testing can efficiently detect a performance flaw in a very short time (often between 2.0 and 3.5 real-time units).

Generally, the work described herein presents an efficient realization for the integration of both network management areas.

2. Possible Extensions

There are a number of issues and problems that could be investigated further. Some of them are briefly discussed below.

More performance metrics, such as the frequency of performance flaws and the mean time between such flaws, can be evaluated to promote the effectiveness of our passive testing approach.

As indicated here, our passive testing based network management approach can be scaled to embrace the advantages of the performance management. This leads to another possible extension to the work presented here to scale it more to cover another important area of network management, namely security management. Passive observation can be very appropriate for the nature of the security management domain.

Extending the performance management to support more features besides performance flaw detection, such as flaw identification, may also be desirable.

Another possible extension is handling a fault and a performance flaw when both occur simultaneously, or co-exist in the network. This can lead to the idea of merging the results from fault management and performance management to get a better identification of the network problems.

The present work can also be extended to include more than one fault/flaw. However, coexistence of multiple faults/flaws in the system will complicate the process of fault management.

Another challenge is to see how the techniques that have been developed for passive testing might be applied in the fault management systems of real network management tools. This somewhat formal approach and way of thinking seems to be quite distant from the techniques currently used in actual network management systems.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of detecting performance flaws in a network, using passive testing, comprising the steps of:
modeling a network by employing a plurality of nodes, wherein each of the nodes represents a machine and wherein at least some of the nodes are connected to each other;
placing an observer at selected ones of the plurality of nodes, the observer being able to compute delays, throughput and utilization;
observing input/output sequences for the selected nodes and comparing those input/output sequences with predetermined expected behaviors; and
identifying areas of the machine in which discrepancies between the input/output sequences and the expected behaviors occur, and for an area so identified:
monitoring a generation time and arrival time of a selected input/output sequence and computing an end-to-end delay of a corresponding input/output pair;
monitoring the number of input/output pairs passing through one of the selected nodes and determining whether the number is above or below a predetermined number per unit of time; and
determining a utilization factor for a selected channel in the machine.

2. The method of claim 1, wherein the method is applied to an aeronautical telecommunications network.

3. The method of claim 1, wherein the modeling comprises employing communicating finite state machines.

4. The method of claim 1, wherein the observer knows the structure of the machine and can trace input/output sequences.

5. The method of claim 1, wherein the step of identifying areas of the machine comprises employing node cuts.

6. The method of claim 1, wherein the generation time is appended to an information packet traveling through the network.

7. The method of claim 1, wherein the utilization factor is determined by computing a percentage of time the channel is used.

8. The method of claim 1, further comprising detecting faults in the network.

9. A method of detecting performance flaws in a network, comprising the steps of:
modeling a communicating finite state machine comprising a plurality of machines at least some of which are connected to each other via a plurality of channels, wherein each machine is defined as a single node six-tuple FSM along with a time stamp;
placing an observer at selected ones of the plurality of nodes, the observer being able to compute delays, throughput and utilization;
observing input/output sequences for the selected nodes and comparing those input/output sequences with predetermined expected behaviors; and
identifying areas of the machine in which discrepancies between the input/output sequences and the expected behaviors occur, and for an area so identified:
monitoring the time stamp and arrival time of a selected input/output sequence and computing an end-to-end delay of a corresponding input/output pair;
monitoring the number of input/output pairs passing through one of the selected nodes and determining whether the number is above or below a predetermined number per unit of time; and
determining a utilization factor for a selected channel in the communicating finite state machine.

10. The method of claim 9, wherein the method is applied to an aeronautical telecommunications network.

11. The method of claim 9, wherein the observer knows the structure of the communicating finite state machine and can trace input/output sequences.

12. The method of claim 9, wherein the step of identifying areas of the machine comprises employing node cuts.

13. The method of claim 9, wherein the utilization factor is determined by computing a percentage of time the channel is used.

14. The method of claim 9, further comprising detecting faults in the communicating finite state machine.

15. A passive testing method for detecting performance flaws in a network, comprising the steps of:
modeling a communicating finite state machine comprising a plurality of machines at least some of which are connected to each other via a plurality of channels, wherein each machine is defined as a single node six-tuple FSM along with a time stamp;
placing an observer at selected ones of the plurality of nodes, the observer being non-intrusive to the communicating finite state machine;
observing input/output sequences for the selected nodes and comparing those input/output sequences with predetermined expected behaviors;
monitoring the time stamp and arrival time of a selected input/output sequence and computing an end-to-end delay of a corresponding input/output pair;
monitoring the number of input/output pairs passing through one of the selected nodes and determining whether the number is above or below a predetermined number per unit of time; and
determining a utilization factor for a selected channel in the communicating finite state machine.

16. The method of claim 15, wherein the method is applied to an aeronautical telecommunications network.

17. The method of claim 15, wherein the observer knows the structure of the communicating finite state machine and can trace input/output sequences.

18. The method of claim 15, further comprising node employing cuts to identify areas of the communicating finite state machine to analyze.

19. The method of claim 15, wherein the utilization factor is determined by computing a percentage of time the channel is used.

20. The method of claim 15, further comprising detecting faults in the communicating finite state machine.
